(19) United States
(12) Patent Application Publication
(10) Pub. No.: US 2017/0218740 A1
(43) Pub. Date: Aug. 3, 2017

(54) SUBTERRANEAN CONVERSION OF CARBON DIOXIDE TO BIOMASS BY CHEMOLITHOTROPY

(71) Applicant: Craig Pichach, Calgary (CA)

(72) Inventor: Craig Pichach, Calgary (CA)

(21) Appl. No.: 15/008,511

(22) Filed: Jan. 28, 2016

(51) Int. Cl. E21B 43/16; B01D 53/73; B01D 53/84

(52) U.S. Cl. CPC E21B 43/16; B01D 53/84; B01D 53/73; E21B 41/0064

(57) ABSTRACT

A system and method for converting carbon dioxide into biomass within subterranean formations or cavities by introducing chemolithoautotrophic microbes and microbe supporting compounds in the formation so as to cause the chemolithoautotrophic microbes to fix carbon dioxide within the formation into biomass, which can then be used in the production of renewable energy and carbon-based products.

### FIELD OF THE INVENTION

The present invention relates generally to the conversion of carbon dioxide into biomass, more specifically, relating to the conversion of carbon dioxide to biomass in a subterranean formation by chemolithotropy.

### BACKGROUND OF THE INVENTION

Global warming continues to be a great concern of many environmental scientists. Scientists believe that the greenhouse effect caused by increasing emissions of heat trapping gases is responsible for an undesirable rate of global warming and climate change. These gases, such as carbon dioxide (CO2), accumulate in the atmosphere and allow sunlight to stream in freely but block heat from escaping (greenhouse effect).

Capturing and storing CO2 produced by industrial processes or by scrubbing CO2 from ambient air are a potential means for reducing the greenhouse effect and slowing global warming. One method captures CO2 and injects the captured CO2 into a geological formation for long term storage. While sequestering CO2 in geological formations is known, this is a relatively new concept. Several methods have been developed to convert captured CO2 into biomass but at surface with large surface footprints due to solar requirements or with expensive feedstocks such as sugar. After the biomass is produced, it may be used to generate power, petrochemicals or hydrocarbon fuels.

Method and systems for chemoautotrophic production of organic compounds are also known. For example, U.S. Pat. No. 8,349,587 describes such a method and system, and is incorporated herein in its entirety by reference. Methods for sustaining microbial activity in subterranean formations by introducing microbial nutrients are known. For example, U.S. Pat. No. 5,363,913 describes such a method, and is incorporated herein in its entirety by reference. Similarly, U.S. Pat. No. 6,543,535, which is incorporated herein in its entirety by reference, describes a process for stimulating microbial activity in a hydrocarbon-bearing, subterranean formation. Additionally, U.S. Pat. No. 4,845,034, which is also incorporated herein in its entirety by reference, describes biochemically reacting substrates in subterranean cavities.

However, nothing currently exists to convert CO2 that is sequestered in a subterranean formation into biomass that can be used to produce renewable energy and carbon-based products. Accordingly, a need and desire exists for a system and method for converting CO2 that is sequestered in an underground formation into biomass and recovering the biomass at the surface for beneficial use.

### SUMMARY OF THE INVENTION

In view of the foregoing need and desire, embodiments of the present invention provide a system and method for converting carbon dioxide into biomass within subterranean formations or cavities by introducing chemolithoautotrophic microbes and microbe supporting compounds in the formation so as to cause the chemolithoautotrophic microbes to fix carbon dioxide within the formation into biomass, which can then be used in the production of renewable energy and carbon-based products.

In general, in one aspect, a sulfur-oxidizing subterranean bioreactor is provided. The sulfur-oxidizing subterranean bioreactor broadly contemplates utilizing wells already completed in suitable subterranean formations, or completing one or more wells in a suitable subterranean formation to provide a subterranean bioreactor in which carbon dioxide can be sequestered and converted into biomass by one or more chemolithoautotrophs introduced into the formation.

In general, in another aspect, a method of producing a biomass by oxidizing sulfur or sulfide within a subterranean formation is provided. This method includes the steps of introducing a sulfur-oxidizing bacterium into the formation, wherein said sulfur oxidizing bacterium has a metabolic process that produces biomass from reduced sulfur in the presence of oxygen, causing said sulfur-oxidizing bacterium to produce biomass and oxidized sulfur from sulfur or sulfide that is located within the formation and producing said biomass to surface.

In general, in another aspect, a sulfur-reducing subterranean bioreactor is provided. The sulfur-reducing, subterranean bioreactor broadly contemplates utilizing wells already completed in suitable subterranean formations, or completing one or more wells in a suitable subterranean formation to provide a subterranean bioreactor in which a biomass is produced by reducing oxidized sulfur by one or more sulfur-reducing bacterium introduced into the formation.

In general, in another aspect, a method of producing a biomass by reducing sulfur or sulfate within a subterranean formation is provided. This method includes the steps of introducing a sulfur-reducing bacterium into the formation, wherein said sulfur oxidizing bacterium has a metabolic process that produces biomass from oxidized sulfur in the presence of a hydrogen source, causing said sulfur-reducing bacterium to produce biomass and reduced sulfur from sulfur or sulfate that is located within the formation and producing said biomass to surface.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a schematic view of a sulfur-oxidizing, subterranean bioreactor constructed in accordance with an embodiment of the prevention invention, including a formation, an injection well, and a production well, and which may be continuously operated to convert carbon dioxide in the formation into biomass;

FIG. 2 is a schematic view of a sulfur-oxidizing subterranean bioreactor constructed in accordance with an embodiment of the present invention, including a formation and a single well, and which may be operated on a semi-batch operation to convert carbon dioxide in the formation into biomass;

FIG. 3 is a diagram illustrating a reduction of oxidized sulfur compounds within sulfur-oxidizing subterranean bioreactor by precipitating the sulfur compounds as gypsum in accordance with an embodiment of the present invention;

FIG. 4 is a schematic view of a sulfur-reducing, subterranean bioreactor sulfur constructed in accordance with an embodiment of the prevention invention, including a formation, an injection well, and a production well, and which may be continuously operated to reduce sulfate and produce biomass;

FIG. 5 is a schematic view of a sulfur-reducing, subterranean bioreactor constructed in accordance with an embodiment of the present invention, including a formation and a single well, and which may be operated on a semi-batch operation to reduce sulfate and produce biomass;

FIG. 6 is a diagrammatic view illustrating how CO2 that is converted into biomass by a sulfur-oxidizing, subterranean bioreactor may be used to produce renewable energy and other carbon-based products; and

FIG. 7 is a diagrammatic view of FIG. 6, further illustrating a sulfur-reducing, subterreanean bioreactor producing biomass that may be used to produce renewable energy and other carbon-based products.

### DETAILED DESCRIPTION OF THE INVENTION

Embodiments of the invention provide a system and method for the subterranean conversion of carbon dioxide (CO2) to biomass by chemolithotropy. In certain aspects, one or more chemolithoautotrophs along with other substances that support chemolithotropy are injected into a subterranean formation containing CO2. Within the formation, the chemolithoautotrophs convert the CO2 to biomass, which is then recovered at the surface. Once recovered, the biomass may be used in the production of renewable energy and other carbon-based products. The CO2 may be captured from power plants, industrial processes, or scrubbed from ambient air an injected into the subterranean formation for conversion into biomass.

The subterranean formation may be a depleted oil and gas reservoir, a depleted coal seam, or a depleted salt cavern, for example. Other formations may also be used. As a non-limiting example, naturally occurring or artificially made underground caverns may be used as the subterranean formation. It is desirable for the subterranean formation to include an adequate overburden and underburden formation rock to prevent fluid migration into groundwater. And, particularly, the subterranean formation must be of a structure that allows for the storage of CO2 within the formation without substantial permeation of CO2 into the surrounding ground. The subterranean formation must also have a sufficient permeability and porosity to allow flow within the formation between injection and production wells. It is contemplated that a formation with a limited permeability but otherwise having a suitable overburden and underburden formation rock might benefit from hydraulic fracking to encourage communication between the injection and production wells.

The subterranean formation must also be located at a depth where naturally occurring temperatures fall within the ideal environmental temperature of the selected chemolithoautotrophs in order to sustain an optimal growth rate of the microbes. A subterranean formation will be selected after a geological analysis is completed to ensure that the formation is suitable to support chemolithotropy within the formation by the selected chemolithoautotrophs.

A chemolithoautroph, sometimes referred to as a chemoautroph, is a type of lithoautroph microbe that derives energy from reduced mineral compounds by chemolithotropy. Certain chemolithoautrophs are able to fix CO2 into organic compounds as part of their metabolic process thus producing a biomass that may be used in the production of renewable energy and other carbon-based products. Possible chemolithoautotrophs include Thiomicrospira Crunogena, Thiomicrospira Frisia, Thiomicrospira Chilensis, Thiomicrospira Pelophila, Thiobacillus Novellus, Thiobacillus sp. ASWW-2.

As a non-limiting example, one such chemolithoautotroph is Thiomiscrospira Crunogena (T. Crunogena), which is a Gammaproteobacterium that is often found around hydrothermal vents. T. Crunogena derives energy from reduced sulfur compounds (sulfide, thiosulfate or elemental sulfur) using oxygen as an electron acceptor. Hydrogen Sulfide gas (H2S) has been shown to be an effective sulfide source for the growth of T. Crunogena. T. Crunogena uses the oxidation of reduced sulfur compounds (sulfide, thiosulfate, and elemental sulfur) as an energy source for carbon fixation as biomass.

The environmental conditions around hydrothermal vents, in which T. Crunogena thrive, can be reproduced within a subterranean formation to the extent that T. Crunogena will grow at an adequate rate to fix CO2 in the production of biomass. A temperature of 28-32° C. and a pH of 7.5-8 provide an optimal environment for the growth of T. Crunogena.

Depending upon the geology of the selected subterranean formation and the metabolic requirements of the selected chemolithoautotroph, substances required to support chemolithotropy, such as, reduced sulfur and oxygen, are injected into the formation to create a controlled environment to promote CO2 fixing and growth of the chemolithoautotroph. For example, the pH of the environment may be controlled by periodic or continuous addition of appropriate acids, bases, or buffers into the formation. Similarly, substances required for growth of the chemolithoautotroph may be supplemented periodically or continuously.

Additionally, the concentration of toxic substances in the formation may be controlled by continuous or periodic addition of neutralizing agents into the formation or by continuous or periodic removal of the toxin from the formation. Similarly, biochemical products produced by the growth of the chemolithoautotroph may be continuously or periodically removed. In certain aspects, the system and method may benefit by converting within the formation certain biochemical products to create substances required for the growth of the chemolithoautotroph.

For example, in addition to producing biomass, T. Crunogena also produces oxidized sulfur. Since T. Crunogena requires the presence of a reduced sulfur compound to grow, it may be desirable to reduce the oxidized sulfur within the formation to provide a reduced sulfur compound to support growth of T. Crunogena within the formation. In certain aspects, the oxidized sulfur may be reduced within the formation along with CO2 fixation. Such a process would be beneficial for at least two reasons. First, the process would provide a source of reduced sulfur within the formation to support the chemolithoautroph without having to inject a source of reduced sulfur into the formation. Second, the process would result in additional fixation of CO2 located within the formation.

In one aspect, a sulfate reducing bacteria could be injected into the subterranean formation. The sulfate bacteria obtain energy by oxidizing organic compounds or molecular hydrogen (H2) while reducing sulfate to hydrogen sulfide. Possible sulfate reducing bacteria include Thermodesulfobacterium Hydrogeniphilum, Thermodesulfobacterium Commune, Thermodesulfobacterium Thermophilum, Thermodesulfobacterium Hveragerdense, Geothermobacterium Ferrireducens, Thermosulfidibacter Takaii, Desulfurobacterium Thermolithotrophum, Desulfurobacterium Crinifex, Desulfurobacterium Pacificum, Desulfurobacterium Atlanticum, Thermovibrio Ruber, Thermovibrio Ammonificans, Thermovibrio Guaymasensis, Balnearium Lithotrophicum, Thermodesulfobacterium Commune, Thermodesulfobacterium Mobile, Thermodesulfobacterium Hveragerdense, Thermodesulfobacterium Hydrogeniphilum, Thermodesulfatator Indicus, Geothermobacterium Ferrireducens, Thermodesulfobacterium Geofontis, Thermodesulfobacterium Hydrogenophilus, Thermodesulfobacterium Latus, Thermodesulfobacterium Curvatus, Desulfmicrobium Norvegicum, Desulfmicrobium Hypogeium, Desulfmicrobium Salsuginis, Desulfmicrobium Awestuarii, Desulfmicrobium Escambiense, Desulfmicrobium Macestii, Desulfmicrobium Aspheronum, Desulfmicrobium Baculatum, Desulfmicrobium Orale, Desulfmicrobium Thermophilum, Desulfovibrio Vulgari, Desulfovibrio Desulfuricans, Desulfovibrio Desulfuricans, Desulfovibrio Gigas, Desulfovibrio Zosterae, Desulfobacter Hydrogenophilus, Desulfobacter Postgatei, and Defulfotomaculum Acetoxidans.

It is important to note, while certain microbes are identified above, it is believed that one of ordinary skill in the art with the benefit of this paper would be able to select microbes which are suitable for the subterranean conversion of CO2 to biomass by chemolithotropy.

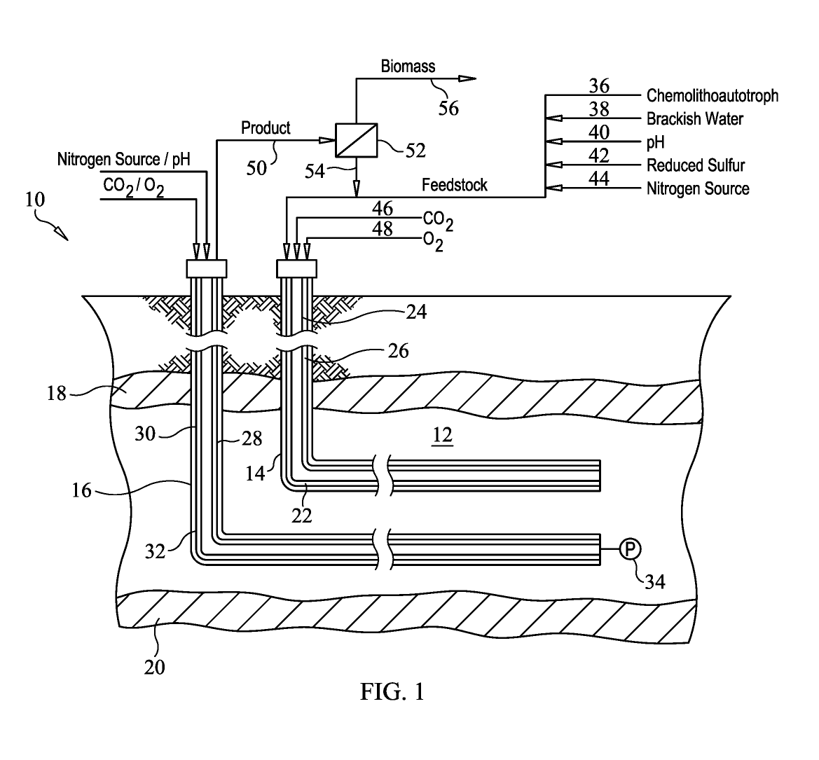

Turning now to FIG. 1, there is schematically illustrated a subterranean bioreactor 10 constructed in accordance with an embodiment of the invention, referred to herein as either a subterranean bioreactor or a bioreactor. In this embodiment, bioreactor 10 is depicted as sulfur oxidizing bioreactor using a reduced sulfur oxidizing chemolithoautotroph, such as, for example T. Crunogena to convert CO2 into biomass. As shown, bioreactor 10 includes a suitable subterranean formation 12, an injection well 14 and a production well 16. The formation 12 is located at a depth where naturally occurring temperatures are between 10-20° C. for psychrophilic microorganisms, 30-40° C. for mesophilic microorganisms, and 50-60° C. for thermophilic microorganisms. In the case of T. Crunogena, the depth is such that the temperature is preferably 28-32° C. The formation 12 further includes suitable overburden and underburden rock 18 and 20, respectively.

The injection well 14 is shown as a horizontal well and completed using conventional methods, including cementing to retain its position and prevent fluid migration between subsurface formations. The injection well 14, however, could be a vertical well and should not be limited to a horizontal well configuration. As depicted, the injection well 14 has an openhole or slotted liner completion, and, in certain instances where the formation has high permeability, porosity, or both the injection well 14 can be completed with a gravel or prop pack, or with a slotted liner or wire wrapped screen (not shown).

As shown, the injection well 14 representatively, includes a feedstock injection string 22, a CO2 injection string 24, and an O2 injection string 26. It should be understood that fewer or additional injection strings may be used as desired, and the system and method of the present invention should not be limited in any manner to the particular depicted well configuration.

With continued reference to FIG. 1, similar to the injection well 14, the production well 16 is shown as a horizontal well and completed using conventional methods, including cementing to retain its position and prevent fluid migration between subsurface formations. The production well 16, however, could be a vertical well and should not be limited to a horizontal well configuration. As depicted, the production well 16 has an openhole or slotted liner completion, and, in certain instances where the formation has high permeability, porosity, or both the production well 16 can be completed with a gravel or prop pack, or with a slotted liner or wire wrapped screen (not shown).

Representatively illustrated, the production well 16 includes a production string 28 and injection strings 30 and 32. As further shown, the production well 16 is completed so as to be in communication with a lower section of the formation 12, while the injection well 14 is completed so as to be in communication with an upper section of the formation. In such an arrangement, it may be desirable into inject certain chemolithotropic supporting substances through the production well 16. Accordingly, as depicted, an ammonia source or pH adjusting compound may be injected into the formation through string 30 and O2 or CO2 may be injected into the formation through string 32. Of course, other configurations are possible, and the invention should not be limited to the depicted production well configuration.

Returning to the injection well 14, one or more chemolithoautotrophs 36, in the representatively illustrated embodiment T. Crunogena, is placed into the formation 12 through injection string 22. Water (in this instance saline or brackish water) 38, pH adjusting substance (e.g., base, acid, buffer) 40, reduced sulfur compound (e.g., H2S, elemental sulfur, etc.) 42, and a nitrogen source 44 or compound from which nitrogen can be derived such as, for example, ammonia are optionally injected separately or in any combination along with the chemolithoautotrophs or separately as needed to maintain growth of the chemolithoautotrophs within the formation. Additionally, CO2 46 that is captured from an industrial process or scrubbed from the ambient air is injected into the formation 12 through string 24 and oxygen 48 (either pure or atmospheric air) is injected into the formation through string 26.

Chemolithotropic supporting substances may also be injected into the formation 12 through strings 30 and 32 run through the production well 16. As depicted, the nitrogen source and the pH adjuster are injected together or separately through string 30 and CO2 and O2 are injected together or separately through string 32. However, any of the aforedescribed compounds, substances or nutrients, including the chemolithoautotroph may be injected into the formation 12 through one or more strings run through the production well 16 as desired to support chemolithotropy within the formation. Optionally, a blanket fluid may be injected into the injection well and production wells 14 and 16.

Once the chemolithotroph is injected into the formation 12 along with substances to support chemolithotropy, the CO2 contained within the formation is fixed into biomass via growth of the chemolithoautotroph within the formation. After a sufficient length of time, fluid 50 is produced from the formation via production string 28, using a pump 34 if required. The produced fluid 50 includes biomass comprising the chemolithoautotrophy that has grown in the formation 12 and possibly other biochemical products which are formed by the growth of the chemolithoautotrophy in the formation.

The produced biomass will have a density that is elevated from the density of the chemolithoautotrophy that is injected into the formation 12. Preferably, the biomass will have a density at or above 0.7 kg/m³. At the surface, a conventional culture rotary drum, filter system or membrane separation system 52 is used to remove additional biomass to return the slurry biomass 54 to a density that of optimum injection density (0.7 g/L) which in turn is recycled back to the bioreactor 10. In embodiments additional feedstock slurry, oxygen, reduced sulfur compounds such as elemental sulfur or hydrogen sulfide, carbon dioxide, a nitrogen source or base is injected into to further support chemolithotropy within the formation. Biomass stream 56 may be further processed to produce a renewable energy or carbon-based products.

In the embodiment depicted in FIG. 1, the bioreactor 10 may be continuously operated once the chemolithoautotroph begins to grow to a desirable density, such as, for example 0.7 kg/m³. During continuous operation, chemolithotropy supporting compounds are continuously or periodically injected as required to maintain growth of the chemolithoautotroph within the formation in order to fix CO2 into biomass which can then be produced from the bioreactor.

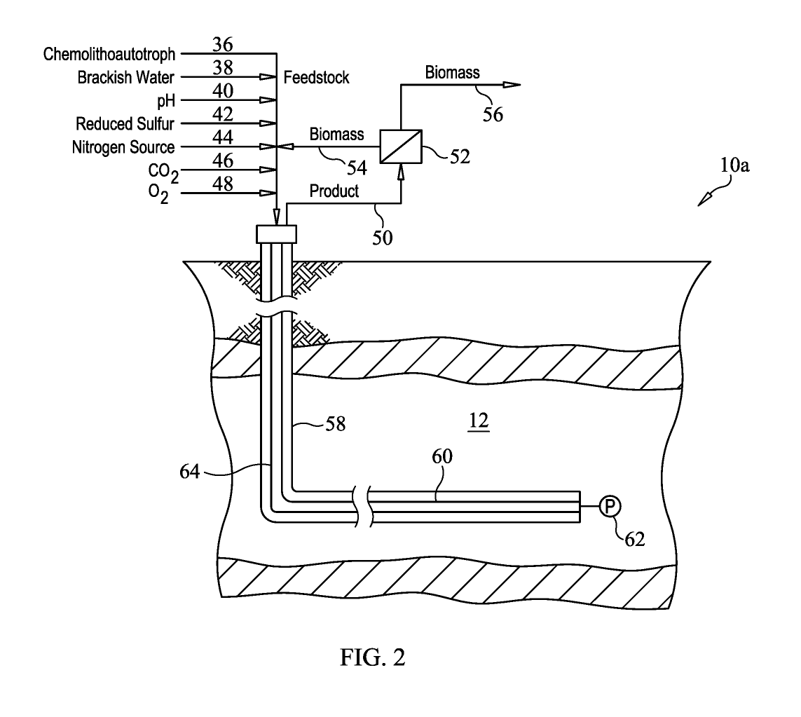

In certain instances, it might be desirable to have a bioreactor construction that includes a single well for both injection and production, for example when the formation is highly porous or if a semi-batch operation is desired to reduce capital costs. With reference to FIG. 2, there is schematically illustrated a subterranean bioreactor 10a having a single well construction. As depicted bioreactor 10a, includes well 58 shown as a horizontal well and completed using conventional methods, including cementing to retain its position and prevent fluid migration between subsurface formations. Well 58, however, could be a vertical well and should not be limited to a horizontal well configuration. As depicted, the well 58 has an openhole or slotted liner completion, and, in certain instances where the formation12 has high permeability, porosity, or both the well 58 can be completed with a gravel or prop pack, or with a slotted liner or wire wrapped screen (not shown).

As shown, well 58 has a production string 60, with an optional downhole pump 62, and one or more injection strings 64. Similar to bioreactor 10, chemolithoautotrophs 36, water (in this instance saline or brackish water) 38, pH adjusting substance (e.g., base, acid, buffer) 40, reduced sulfur compound (e.g., H2S, elemental sulfur, etc.) 42, and a nitrogen source 44 or compound from which nitrogen can be derived such as, for example, ammonia, CO2 46, and 02 48 are injected separately or in any combination along as needed to maintain growth of the chemolithoautotrophs within the formation 12.

Once the chemolithoautotroph is injected into the formation 12 along with substances to support chemolithotropy, the CO2 contained within the formation is fixed into biomass via growth of the chemolithotrophy within the formation. After a sufficient length of time, fluid 50 is produced from the formation via production string 60, using a pump 62 if required. The produced fluid 50 includes biomass comprising the chemolithoautotrophy that has grown in the formation 12 and possibly other biochemical products which are formed by the growth of the chemolithoautotrophy in the formation.

At the surface, a conventional culture rotary drum, filter system or membrane separation system 52 is used to remove additional biomass to return the slurry biomass 54 to a density that of optimum injection density which in turn is recycled back to the bioreactor 10a. Biomass stream 56 may be further processed to produce a renewable energy or carbon-based products.

Operation of the bioreactor with a sulfur oxidizing chemolithoautotroph, such as, for example T. Crunogena results in the production of oxidized sulfur compounds (e.g., sulfates). Overtime, the oxidized sulfur compounds may build up within the formation and have a negative effect on sustaining chemolithotropy within the formation. Thus, it may be desirable to reduce the concentration of the oxidized sulfur compounds in order to sustain chemolithotropy within the formation.

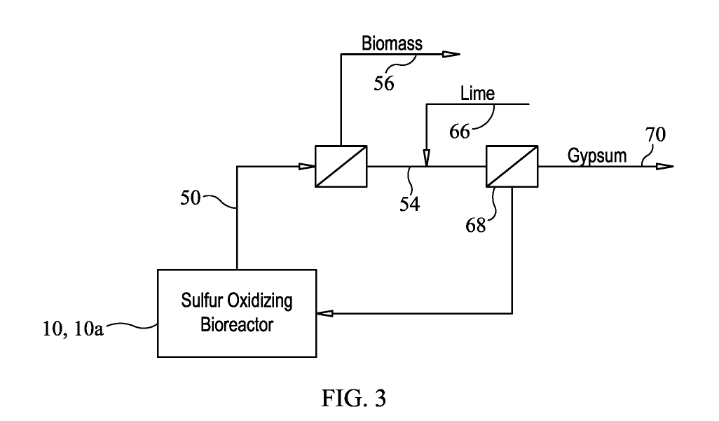

With reference to FIG. 3, there is illustrated a block diagram illustrating a reduction of oxidized sulfur compounds in connection with subterranean bioreactor 10, 10a. As depicted, fluid 50 produced from the bioreactor 10, 10a is passed through separator 52 to produce biomass stream 56 and biomass recycle stream 54 as discussed above. Here, lime 66 is added to the biomass recycle stream 54 in order to precipitate oxidized sulfur as gypsum. The gypsum is removed from the biomass recycle stream 54 by separator 68, which produces a gypsum stream 70 and a second biomass recycle stream 72 that has a reduced concentration of oxidized sulfur, which is then returned to the bioreactor.

In some instances, it may be more desirable to reduce the oxidized sulfur into a reduced sulfur compound to support chemolithotropy by a sulfur oxidizing chemolithoautroph (e.g., T. Crunogena), rather than precipitating the oxidized sulfur as gypsum. As discussed above, such a process would be beneficial for at least two reasons. First, the process would provide a source of reduced sulfur within the formation to support the sulfur oxidizing chemolithoautroph, thus lowering the need to inject reduced sulfur into the formation. Second, the process would result in additional fixation of CO2 located within the formation along with the production of biomass.

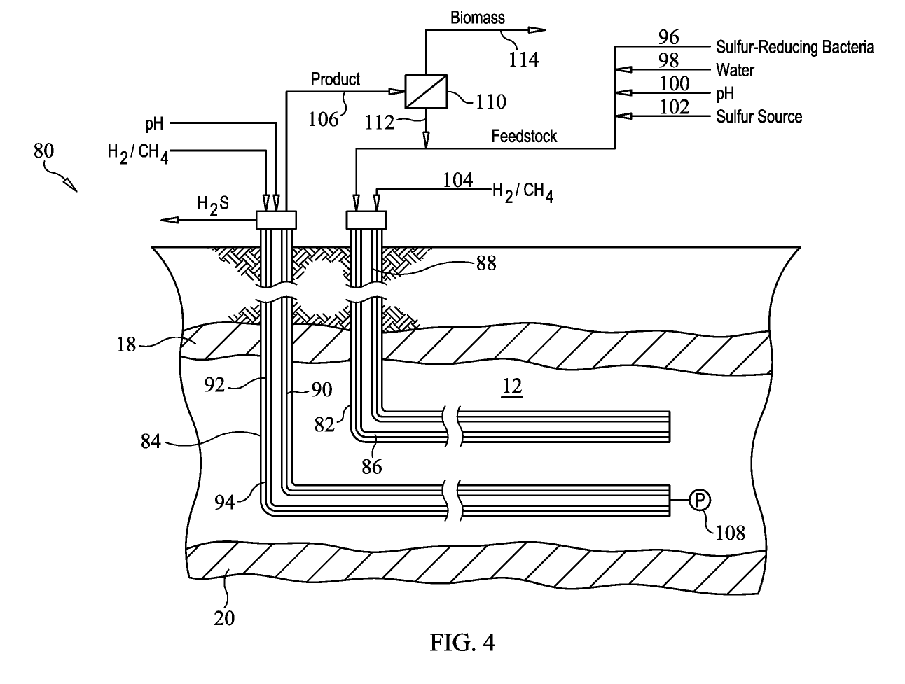

In FIG. 4, there is schematically illustrated a subterranean sulfur reducing bioreactor 80 constructed in accordance with an embodiment of the invention. In an embodiment, the sulfur reducing bioreactor 80 is configured to sustain the growth of a chemolithoautotrophic sulfate-reducing bacterium, such as, for example, Thermodesulfatator indicus, which is a thermophilic, marine, chemolithoautotroph that uses sulfate as an electron acceptor in its metabolic process. Of course, while the following discussion is made in connection with Thermodesulfatator indicus as the sulfate-reducing bacterium, other sulfate-reducing bacterium may also be utilized.

Bioreactor 80 could be bioreactor 10 that has been reconfigured from a sulfur oxidizing bioreactor to a sulfur reducing bioreactor. Alternatively, bioreactor 80 could be created using the same formation 12 used in bioreactor 10. In either instance, bioreactor 80 includes the formation 12, an injection well 82, and a production well 84. If the bioreactor 80 is converted from bioreactor 10, the injection well 14 of bioreactor 10 would be configured as injection well 82 of bioreactor 80. Likewise, production well 16 of bioreactor 10 would be configured as production well 84 of bioreactor 80.

As shown, the injection well 82 representatively, includes a feedstock injection string 86 and a H2 or CH4 injection string 88. It should be understood that fewer or additional injection strings may be used as desired, and the system and method of the present invention should not be limited in any manner to the particular depicted well configuration.

Representatively illustrated, the production well 84 includes a production string 90 and injection strings 92 and 94. As further shown, the production well 84 is completed so as to be in communication with a lower section of the formation 12, while the injection well 82 is completed so as to be in communication with an upper section of the formation. In such an arrangement, it may be desirable into inject certain sulfur-reducing bacteria metabolic supporting substances through the production well 84. Accordingly, as depicted, an ammonia source or pH adjusting compound may be injected into the formation through string 92 and either H2, CH4, or both may be injected into the formation through string 94. Of course, other configurations are possible, and the invention should not be limited to the depicted production well configuration.

Returning to the injection well 82, one or more sulfate-reducing bacterium 96, in the representatively illustrated embodiment, Thermodesulfatator Indicus, is placed into the formation 12 through injection string 88. Water (in this instance saline or brackish water) 98, pH adjusting substance (e.g., base, acid, buffer) 100, and optionally sulfate 102 injected separately or in any combination along with the sulfate-reducing bacterium or separately as needed to maintain growth of the sulfate-reducing bacterium within the formation. Additionally, either H2, CH4, or both are injected into the formation 12 through string 86. The H2 or CH4 is used by the sulfate-reducing bacterium to support growth.

Once the sulfate-reducing bacterium is injected into the formation 12 along with substances to support growth of the sulfate-reducing bacterium, the oxidized sulfur contained within the formation is reduced via the growth and metabolic processes of the sulfate-reducing bacterium. After a sufficient length of time, fluid 106 is produced from the formation via production string 90, using a pump 108 if required. The produced fluid 106 includes biomass comprising the sulfate-reducing bacterium that has grown in the formation 12 and possibly other biochemical products which are formed by the growth of the sulfate-reducing bacterium in the formation.

The produced biomass will have a density that is elevated from the density of the sulfate-reducing bacterium that is injected into the formation 12. Preferably, the biomass will have a density at or above 0.7 kg/m³. At the surface, a conventional culture rotary drum, filter system or membrane separation system 110 is used to remove additional biomass to return the slurry biomass 112 to a density that of optimum injection density which in turn is recycled back to the bioreactor 80. In embodiments, additional compounds 98, 100, 102 and 104 is injected to further support growth of the sulfate-reducing bacterium within the formation. Biomass stream 114 may be further processed to produce a renewable energy or carbon-based products.

In the embodiment depicted in FIG. 4, the bioreactor 90 may be continuously operated once the sulfate-reducing bacterium begins to grow to a desirable density, such as, for example 0.7 kg/m³. During continuous operation, chemolithotropy supporting compounds are continuously or periodically injected as required to maintain growth of the sulfate-reducing bacterium within the formation in order to reduce the sulfate and produce biomass, which can then be produced from the bioreactor.

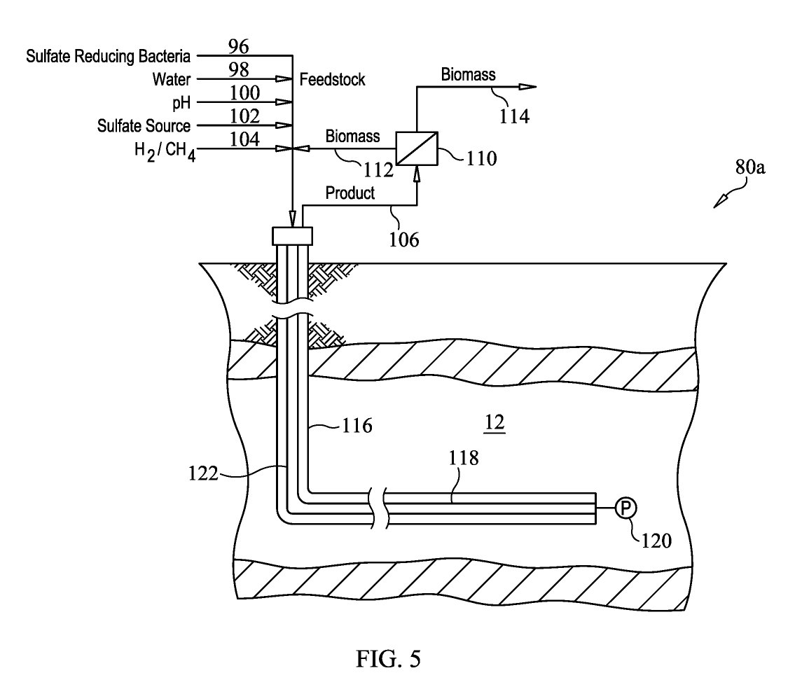

Similar to bioreactor 10, in certain instances, it might be desirable to have a sulfate-reducing bioreactor construction that includes a single well for both injection and production, for example when the formation is highly porous or if a semi-batch operation is desired to reduced capital costs. With reference to FIG. 5, there is schematically illustrated a subterranean sulfate-reducing bioreactor 80a having a single well construction.

Bioreactor 80a could be bioreactor 10a that has been reconfigured from a sulfur oxidizing bioreactor to a sulfur reducing bioreactor. Alternatively, bioreactor 80a could be created using the same formation 12 used in bioreactor 10a. In either instance, bioreactor 80a includes the formation 12 and well 116. If the bioreactor 80a is converted from bioreactor 10a, the well 58 of bioreactor 10a would be configured as well 116 of bioreactor 80a.

The well 116 has a production string 118, with an optional downhole pump 120, and one or more injection strings 122. Similar to bioreactor 80, sulfate-reducing bacterium 96, water (in this instance saline or brackish water) 98, pH adjusting substance (e.g., base, acid, buffer) 100, optionally sulfate 102, and H2, CH2 or both are injected separately or in any combination as needed to maintain growth of the sulfate-reducing bacterium within the formation 12. Bioreactor 80a is operated similarly to bioreactor 10a as discussed above.

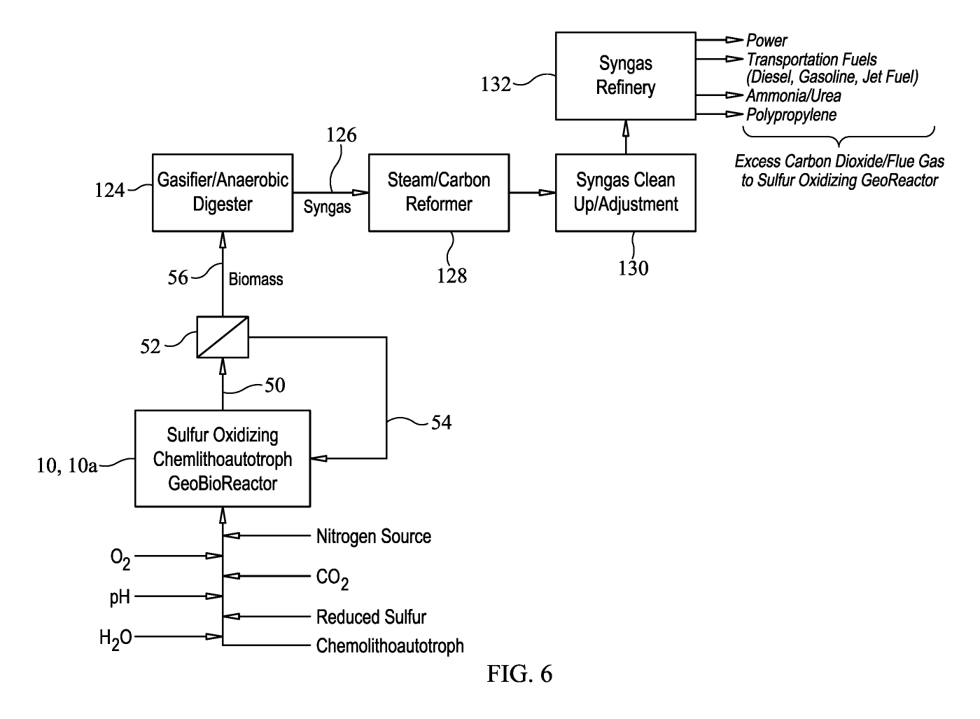

With reference to FIG. 6, there is diagram illustrating how CO2 that is converted into biomass by sulfur oxidizing bioreactor 10, 10a may be used to produce renewable energy and other carbon-based products. For example, biomass 56 produced by bioreactor 10, 10a may be processed by a gasifier or anaerobic digester 124 to produce syngas 126. The syngas 126 may be further processed by a steam/carbon reformer 128, chemically adjusted 130, and refined 132 for use in industrial processes such as producing electrical power, transportation fuels, ammonia/urea production, polypropylene production, etc. Then the CO2 produced by these industrial process may be captured and returned to the bioreactor 10, 10a to converted into biomass. While not shown in FIG. 6, lime may be added to the biomass recycle stream 54 in order to precipitate oxidized sulfur as gypsum as discussed above with reference to FIG. 3.

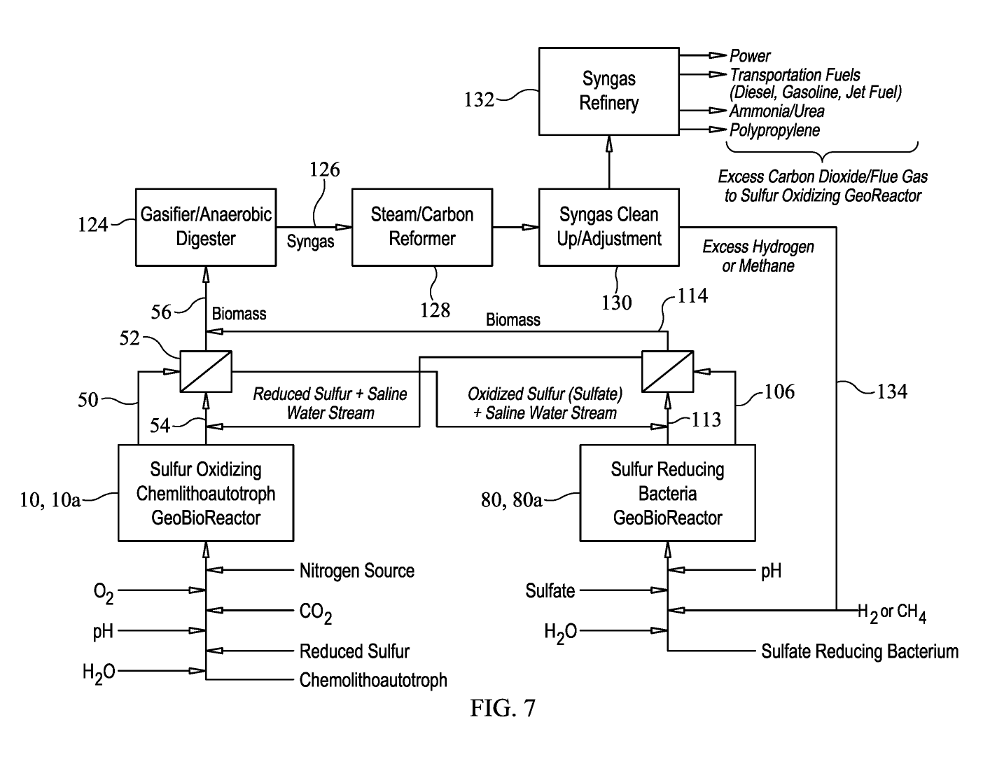

With reference to FIG. 7, there is diagram illustrating how CO2 that is converted into biomass by sulfur oxidizing bioreactor 10, 10a may be used to produce renewable energy and other carbon-based products in connection with a sulfate reducing bioreactor 80, 80a also producing biomass that may be used to produce renewable energy and other carbon-based products. Here, biomass 114 produced by the sulfate reducing bioreactor 80, 80a is combined with the biomass 56 produced by the sulfur oxidizing bioreactor 10, 10a and processed like discussed above with respect to FIG. 6. Additionally, hydrogen, methane, or both 134 may be removed at 130 and recycled into bioreactor 80, 80a. Further, fluid stream 136 from separator 52, containing sulfate and water may be recycled into bioreactor 80, 80a and fluid stream 138, containing reduced sulfur and water may be recycled into bioreactor 10, 10a.

A number of embodiments of the present invention have been described. Nevertheless, it will be understood that various modifications may be made without departing from the spirit and scope of the invention. Accordingly, other embodiments are within the scope of the following claims.

1. A method of converting carbon dioxide to biomass by chemolithotropy, the method comprising the steps of:
introducing one or more chemolithoautotrophs into a subterranean formation through one or more wells extending from a surface into said subterranean formation, wherein at least one of said chemolithoautotrophs has a metabolic process that fixes carbon dioxide into biomass;
introducing one or more reduced sulfur compounds along with brackish water and oxygen into said subterranean formation through at least one well of said one or more wells;
causing said at least one of said chemolithoautotrophs to fix carbon dioxide located within said subterranean formation into biomass; and
producing said biomass at the surface from said subterranean formation through at least one well of said one or more wells.

2. (canceled)

3. The method of claim 1, further comprising the step of:
introducing chemolithotropic supporting compounds into said subterranean formation through at least one well of said one or more wells.

4. The method of claim 1, wherein said at least one of said chemolithoautotroph is a sulfur oxidizing microbe.

5. The method of claim 4, wherein said sulfur oxidizing microbe is Thiomicrospira Crunogena.

6. The method of claim 4, wherein oxygen is injected, through at least one well of said one or more wells, into said subterranean formation for use as an electron acceptor for said sulfur oxidizing microbe.

7. The method of claim 1, wherein said one or more reduced sulfur compounds are injected, through at least one well of said one or more wells, into said subterranean formation to be oxidized by said one or more chemolithoautotrophs.

8. The method of claim 1, further comprising the step of:
producing sulfate at the surface from said subterranean formation, through at least one well of said one or more wells, along with a carbon-based compound; and
precipitating the produced sulfate as gypsum.

9. The method of claim 1, further comprising the step of:
introducing carbon dioxide in said subterranean formation through at least one well of said one or more wells.

10. The method of claim 1, further comprising the step of:
recycling a portion of said biomass produced at the surface back into said subterranean formation through at least one well of said one or more wells.

11. A method of converting carbon dioxide to biomass by chemolithotropy, the method comprising the steps of:
introducing one or more sulfur-oxidizing chemolithoautotrophs into a subterranean formation though a first well extending from a surface into said subterranean formation, wherein at least one of said sulfur oxidizing chemolithoautotrophs has a metabolic process that fixes carbon dioxide into biomass and produces sulfate;
introducing one or more reduced sulfur compounds along with brackish water and oxygen into said subterranean formation through said first well;
causing said at least one of said chemolithoautotrophs to fix carbon dioxide located within said subterranean formation into biomass and produce sulfate; and
producing said biomass at the surface from the formation through a second well.

12. The method of claim 11, further comprising the step of:
producing sulfate at the surface from said subterranean formation along with said biomass; and
precipitating the produced sulfate at the surface as gypsum.

13. The method of claim 11, wherein said one or more sulfur-oxidizing chemolithoautotrophs is Thiomicrospira Crunogena.

14. The method of claim 11, wherein oxygen is injected into said subterranean formation, through at least one of said first and second wells, for use as an electron acceptor for said one or more sulfur-oxidizing chemolithoautotrophs.

15. The method of claim 11, further comprising the steps of:
introducing a sulfate-reducing bacterium into said subterranean formation through at least one of said first and second wells, wherein said sulfate-reducing bacterium has a metabolic process that produces biomass and reduced sulfur from sulfate;
causing said sulfate-reducing bacterium to produce biomass and reduced sulfur from sulfate that is located within said subterranean formation;
producing said biomass and said sulfate at the surface through at least one of said first and second wells; and
at least partially recycling said sulfate that is produced back into said subterranean formation through said at least one of said first and second wells.

16. The method of claim 15, wherein said sulfate-reducing bacterium is Thermodesulfatator indicus.

17. The method of claim 11, further comprising the step of:
recycling a portion of said biomass produced at the surface back into said subterranean formation through at least one of said first and second wells.

18. The method of claim 11, further comprising the step of:
introducing chemolithotropic supporting compounds into said subterranean formation through at least one of said first and second wells.

19. A method of producing a biomass by reducing sulfate to sulfur, comprising the steps of:
introducing a sulfate-reducing bacterium into the subterranean formation through one or more wells extending from a surface into said subterranean formation, wherein said sulfate-reducing bacterium has a metabolic process that produces biomass and reduced sulfur from sulfate;
causing said sulfate-reducing bacterium to produce biomass and reduced sulfur from sulfate that is located within said subterranean formation; and
producing said biomass and sulfate at the surface through at least one well of said one or more wells.

20. The method of claim 19, further comprising the step of:
at least partially recycling said sulfate that is produced back into said subterranean formation through at least one well of said one or more wells.

21. The method of claim 20, wherein said sulfate-reducing bacterium is Thermodesulfatator indicus.

22. The method of claim 19, wherein H.sub.2 or organic substrates are injected into said subterranean formation, through at least one well of said one or more wells, to be used as an electron donor for said sulfate-reducing bacterium.

23. The method of claim 19, further comprising the step of:
introducing water into said subterranean formation, through at least one well of said one or more wells, to support and transport organisms.
